(19) United States
(12) Patent Application Publication
(10) Pub. No.: US 2016/0325959 A1
(43) Pub. Date: Nov. 10, 2016

(54) PAPER MONEY TEMPORARY STORAGE MODULE, DRUM ROTATING SPEED CONTROL METHOD THEREOF AND AUTOMATIC TELLER MACHINE

(71) Applicant: GRG Banking Equipment Co., Ltd., Guangzhou City, Guangdong (CN)

(72) Inventors: Qiaoqiao Chen, Guangzhou City, Guangdong (CN); Zhe Li, Guangzhou City, Guangdong (CN); Yunfei He, Guangzhou City, Guangdong (CN); Zhenguang Wang, Guangzhou City, Guangdong (CN)

(73) Assignee: GRG Banking Equipment Co., Ltd., Guangzhou City, Guangdong (CN)

(21) Appl. No.: 15/108,378

(22) PCT Filed: Dec. 16, 2014
(86) PCT No.: PCT/CN2014/093919

§ 371 Date: Jun. 27, 2016

(30) Foreign Application Priority Data
Dec. 30, 2013 (CN) 201310752248.9

(51) Int. Cl. B65H 29/00; G07F 19/00; G05D 13/62

(52) U.S. Cl. CPC B65H 29/006; G05D 13/62; G07F 19/202; B65H 2404/285; B65H 2511/512; B65H 2701/1912

(57) ABSTRACT

A temporary banknote storage module and a method for controlling rotational speeds of reels thereof are provided. The method includes: detecting the flow amount of identification information on a tape in a unit time, calculating to obtain line speeds of a large reel and a small reel, calculating to obtain a first angular speed and a second angular speed according to an expected line speed and a PID algorithm, and controlling a first power motor that corresponds to the large reel and a second power motor that corresponds to the small reel respectively according to the first angular speed and the second angular speed.

### FIELD

This application claims priority to Chinese Patent Application No. 201310752248.9, titled “PAPER MONEY TEMPORARY STORAGE MODULE, DRUM ROTATING SPEED CONTROL METHOD THEREOF AND AUTOMATIC TELLER MACHINE”, filed on Dec. 30, 2013 with the State Intellectual Property Office of the People's Republic of China, which is incorporated herein by reference in its entirety.

### BACKGROUND

An automatic cash recycling system includes a temporary storage module, which temporarily stores a banknote during a transaction process. A temporary storage module commonly used nowadays generally adopts a reel/tape structure including a first power motor, a second power motor, a large reel driven by the first power motor, a small reel driven by the second motor power, the tape and a microcontroller, where two ends of the tape are fixed on the large reel and the small reel respectively, the tape is deployed and retracted between the large reel and the small reel, and the microcontroller controls the first power motor and the second power motor to start or stop. Such a temporary storage module temporarily stores the banknote through cooperation of the reel with the tape.

An operation process is as follows. In a case that the banknote is to be put into the temporary storage module, a first start instruction is sent by the microcontroller to start the first power motor to rotate in a forward direction and start the second power motor to rotate in a backward direction, and the tape is retracted by the large reel and is deployed by the small reel, so that the banknote is stored into the temporary storage module by the reels and the tape. After a preset operation time t, a stop instruction is sent by the microcontroller to stop the first power motor and the second power motor in a case that no new banknote is to be put into the temporary storage module. In a case that a banknote is to leave the temporary storage module, a start instruction is sent by the microcontroller to start the first power motor to rotate in a backward direction and start the second power motor to rotate in a forward direction, the tape is deployed by the large reel and is retracted by the small reel, so that the banknote is sent out from the temporary storage module by the reels and the tape. In a case that all banknotes in the temporary storage module are sent out, a stop instruction is sent by the microcontroller to stop the first power motor and the second power motor. When the banknote enters the temporary storage module, the tape may be easily loosened in a case that a line speed of the small reel is greater than a line speed of the large reel, otherwise, the belt may be tightened in a case that the line speed of the small reel is less than the line speed of the large reel. Similarly, when the banknote leaves the temporary storage module, the tape may be easily loosened in a case that a line speed of the large reel is greater than a line speed of the small reel, otherwise, the tape may be tightened in a case that a line speed of the large reel is less than a line speed of the small reel. Tape looseness is prone to a banknote jam and a fault of a device, thereby increasing manual maintenance work. Tape tightness is prone to tape damage, and is prone to hardware circuit damage due to increased loads of the motors, thereby resulting in a fault of the device and increased manual maintenance work.

During operation of the device, it is required to keep a banknote conveying speed of the tape and a banknote conveying speed of other banknote conveying passage to be constant and consistent. Based on the circular motion principle, line speed V=angular speed co* radius r, thus it is required to keep the line speeds of the large reel and the small reel to be constant, so as to keep the banknote conveying speed of the tape to be constant. As the tape is deployed and retracted between the large reel and the small reel, radiuses of the large reel and the small reel vary continuously, thus it is required to adjust angular speeds of the first power motor and the second power motor timely based on variations of the radiuses of the large reel and the small reel. At present, in a method for controlling rotational speeds of the reels of the temporary banknote storage module, angular speeds of the reels and amount of banknotes are detected by a sensor, the line speeds are obtained through dynamically calculating the radiuses of the reels, and then the angular speeds of the motors corresponding to the reels are adjusted. After one rotation, an increment of the radius of the small reel is constant, which is equal to a thickness of the tape. Since tapes with different specifications differ in thickness, the temporary storage module has poor adaptability to the tapes with different thicknesses. After one rotation, an increment ΔX of the radius of the large reel is equal to the sum of a thickness of the tape plus a thickness of the banknote. Distances between banknotes as well as thicknesses of different banknotes are not uniform, thus ΔX cannot be accurately obtained through calculation, i.e., a rotational radius of the large reel cannot be accurately calculated after the banknote enters the large reel. Therefore, the obtained line speeds of the large reel and the small reel are not accurate, which further leads to large errors in the angular speeds of the first power motor and the second power motor. In this case, the line speeds of the large reel and the small reel are not constant, which leads to different line speeds of the large reel and the small reel. In a case that there is a large deviation between line speeds of the large reel and the small reel, the tape is prone to looseness, or, the hardware circuit is prone to damage due to increased loads of the motors, thereby resulting in a fault of the device and increased manual maintenance work.

### SUMMARY

In view of this, a temporary banknote storage module and a method for controlling rotational speeds of reels thereof are provided in the present disclosure, so as to obtain expected line speeds of a large reel and a small reel, which are constant and are output through accurate control.

To achieve the above objective, the following technical solutions are provided.

A method for controlling rotational speeds of reels of a temporary banknote storage module, including:

counting the number of identifiers detected by a first sensor corresponding to a large reel in a preset time period during operation of the temporary banknote storage module, and recording the number of identifiers detected by the first sensor as a first identifier number, where the identifiers are uniformly arranged in a longitudinal direction of a tape;

counting the number of identifiers detected by a second sensor corresponding to a small reel in the preset time period, and recording the number of identifiers detected by the second sensor as a second identifier number;

calculating a line speed of the large reel and a line speed of the small reel, based on the preset time period, the first identifier number, the second identifier number and a distance between the identifiers; and

substituting the line speed of the large reel, the line speed of the small reel and an expected line speed into a PID algorithm, to calculate a first angular speed and a second angular speed, adjusting a rotational speed of a first power motor corresponding to the large reel to be the first angular speed, and adjusting a rotational speed of a second power motor corresponding to the small reel to be the second angular speed.

Preferably, in the method for controlling the rotational speeds of the reels of the temporary banknote storage module described above, the first angular speed and the second angular speed are calculated in the following step:

calculating the first angular speed and the second angular speed based on an equation:

$$u ( t ) = {K}_{P} [ e ( t ) + \frac{1}{{T}_{I}} {\int }_{0}^{t} e ( t ) d t + \frac{{T}_{D} d e ( t )}{d t} ] ,$$

where the e(t)=r(t)−y(t) is a control error of a system, the r(t) is the expected line speed, the y(t) is the line speed of the large reel or an actual line speed of the small reel, the K_{P} is a proportional coefficient, the T_{I} is an integration time constant, and the T_{D} is a derivative time constant.

Preferably, in the method for controlling the rotational speeds of the reels of the temporary banknote storage module described above, the identifiers include stripes arranged at uniform intervals in the longitudinal direction of the tape.

Preferably, the method for controlling the rotational speeds of the reels of the temporary banknote storage module described above may further include:

comparing, the calculated line speed of the large reel and the calculated line speed of the small reel, with the expected line speed respectively, and controlling the temporary banknote storage module to stop operating in a case that a difference between the line speed of the large reel and the expected line speed or a difference between the line speed of the small reel and the expected line speed is greater than a preset value.

Preferably, the method for controlling the rotational speeds of the reels of the temporary banknote storage module described above may further include:

detecting magnitude of tension of the tape, and controlling the temporary banknote storage module to stop operating in a case that the tension of the tape is larger than a maximum preset tension or the tension of the tape is smaller than a minimum preset tension.

A temporary banknote storage module is provided. The temporary banknote storage module includes a first power motor, a second power motor, a large reel driven by the first power motor and a small reel driven by the second power motor. The temporary banknote storage module may further include:

a tape, where two ends of the tape are fixed on the large reel and the small reel respectively, and identifier information are uniformly arranged on surfaces of the tape in a longitudinal direction of the tape;

a first sensor corresponding to the large reel, configured to detect the identifier information on the tape retracted or deployed by the large reel and output one piece of first identifier information each time one piece of identifier information is detected;

a second sensor corresponding to the small reel, configured to detect the identifier information on the tape retracted or deployed by the small reel and output one piece of second identifier information each time one piece of identifier information is detected; and

a microcontroller, configured to count the number of pieces of first identifier information obtained in a preset time, record the number of pieces of first identifier information as a first identifier number, count the number of pieces of second identifier information obtained in the preset time, record the number of pieces of second identifier information as a second identifier number, calculate a line speed of the large reel and a line speed of the small reel based on the preset time, the first identifier number, the second identifier number and a distance between the pieces of identifier information, obtain a first angular speed corresponding to the first power motor and a second angular speed corresponding to the second power motor based on an expected line speed and a PID algorithm, adjust a rotational speed of the first power motor corresponding to the large reel to be the first angular speed, and adjust a rotational speed of the second power motor corresponding to the small reel to be the second angular speed.

Preferably, in the temporary banknote storage module described above, the microcontroller includes a first PID algorithm module and a second PID algorithm module.

The first PID algorithm module is configured to calculate a first angular speed based on an equation:

$$u 1 ( t ) = {K}_{P} [ e 1 ( t ) + \frac{1}{{T}_{I}} {\int }_{0}^{t} e 1 ( t ) d t + \frac{{T}_{D} d e 1 ( t )}{d t} ] ,$$

where the e1(t)=r(t)−y1(t) is a control error of the large reel of a system, the r(t) is the expected line speed, the y1(t) is the line speed of the large reel, the K_{P} is a proportional coefficient, the T_{I} is an integration time constant, and the T_{D} is a derivative time constant.

The second PID algorithm module is configured to calculate a second angular speed based on an equation:

$$u 2 ( t ) = {K}_{P} [ e 2 ( t ) + \frac{1}{{T}_{I}} {\int }_{0}^{t} e 2 ( t ) d t + \frac{{T}_{D} d e 2 ( t )}{d t} ] ,$$

where the e2(t)=r(t)−y2(t) is a control error of the large reel of the system, and y2(t) is the line speed of the small reel.

Preferably, in the temporary banknote storage module described above, the tape includes:

a tape, where two ends of the tape are fixed on the large reel and the small reel, strips are arranged on surfaces of the tape in a longitudinal direction of the tape, and the strips are identifier information of the tape.

Preferably, in the temporary banknote storage module described above, the microcontroller further includes:

a speed comparison module, configured to compare the calculated line speed of the large reel and the calculated line speed of the small reel with the expected line speed, and control the temporary banknote storage module to stop operating in a case that the a difference between the line speed of the large reel and the expected line speed or a difference between the line speed of the small reel and the expected line speed is greater than a preset value.

Preferably, the temporary banknote storage module described above further includes:

a tester for tension of the tape, configured to detect magnitude of the tension of the tape; where

the temporary banknote storage module is controlled to stop operating in a case that the microcontroller detects that the tension of the tape is larger than a maximum preset tension or the tension of the tape is smaller than a minimum preset tension.

An automatic teller machine is provided. The automatic teller machine may include any one of the temporary banknote storage modules described above.

It can be seen from the above technical solutions that, in the method for controlling the rotational speeds of the reels of the temporary banknote storage module in the present disclosure, the number of pieces of passed identifier information on the tape in a unit of time is detected, and the line speeds of the large reel and the small reel are calculated. Then the first angular speed and the second angular speed are calculated based on the expected line speed and the PID algorithm, and the first power motor corresponding to the large reel and the second power motor corresponding to the small reel are respectively controlled based on the first angular speed and the second angular speed. It can be seen that, in the technical solutions according to above embodiments of the present disclosure, calculations of the line speeds of the large reel and the small reel are not affected by a thickness of the tape, a thickness of a banknote and radiuses of the reels, thus the accurate line speeds of the large reel and the small reel can be obtained, thereby keeping the line speeds of the large reel and the small reel constant.

### BRIEF DESCRIPTION OF THE DRAWINGS

In order to more clearly illustrate technical solutions in embodiments of the present disclosure or in the conventional technology, drawings used in the description of the embodiments or the conventional technology are introduced briefly hereinafter. Apparently, the drawings described in the following merely illustrates some embodiments of the present disclosure, other drawings may be obtained by those ordinarily skilled in the art based on these drawings without any creative efforts.

FIG. 1 is a flow chart of a method for controlling rotational speeds of reels of a temporary banknote storage module according to an embodiment of the present disclosure;

FIG. 2 is a structural diagram of a temporary banknote storage module according to an embodiment of the present disclosure;

FIG. 3 is a diagram of a control principle for a temporary banknote storage module according to an embodiment of the present disclosure;

FIG. 4 is a diagram of identifier information on surfaces of a tape according to an embodiment of the present disclosure; and

FIG. 5 is a diagram of a tape according to an embodiment of the present disclosure.

### DETAILED DESCRIPTION

The technical solutions of embodiments of the present disclosure are clearly and completely described hereinafter in conjunction with the drawings of the embodiments of the present disclosure. Apparently, the described embodiments are only a few of rather than all of the embodiments of the present disclosure. Based on the embodiments of the present disclosure, all other embodiments obtained by those ordinarily skilled in the art without any creative efforts fall within the protection scope of the present disclosure.

In order to obtain expected line speeds of a large reel and a small reel, which are constant and are output through accurate control, a method for controlling rotational speeds of the reels of a temporary banknote storage module is provided in the present disclosure. The control method is a closed-loop control method.

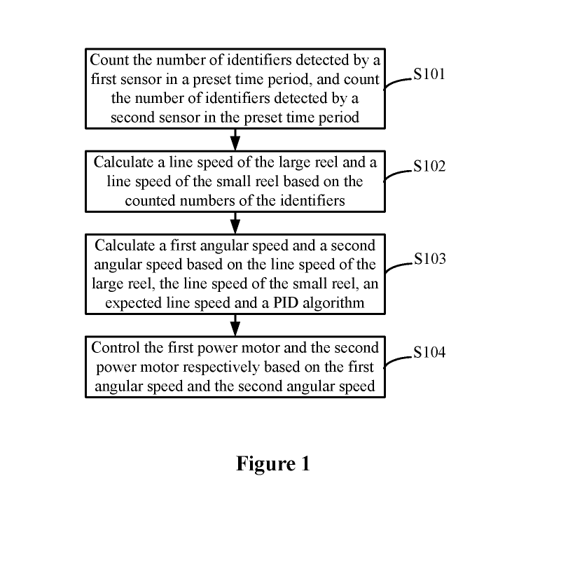

FIG. 1 is a flow chart of a method for controlling rotational speeds of reels of a temporary banknote storage module according to an embodiment of the present disclosure.

The method for controlling the rotational speeds of the reels of the temporary banknote storage module according to the embodiment of the present disclosure is described hereinafter in conjunction with FIG. 1.

Reference is made to FIG. 1, the method for controlling the rotational speeds of the reels of the temporary banknote storage module according to the embodiment of the present disclosure includes steps S101 to S104.

In step S101, the number of identifiers detected by a first sensor in a preset time period is counted, and the number of identifiers detected by a second sensor in the preset time period is counted.

Specifically, the step may include the following. The number of identifiers corresponding to a large reel detected by the first sensor in the preset time period is counted and recorded as a first identifier number, during operation of the temporary banknote storage module, where the identifiers are uniformly arranged in a longitudinal direction of a tape.

During operation of the temporary banknote storage module, the large reel rotates driven by a first power motor, the small reel rotates driven by a second power motor, where pieces of identifier information are uniformly arranged on surfaces of the tape in the longitudinal direction of the tape. The first sensor corresponding to the large reel detects whether there is identifier information, on the tape retracted or deployed by the large reel, passing through a detection region of the first sensor. One first pulse signal may be outputted each time there is one piece of identifier information passing through the detection region of the first sensor. The number of first pulse signals obtained in the preset time period is counted, so that the number of pieces of identifier information arranged on the tape deployed or retracted by the large reel in the preset time period may be obtained and recorded as the first identifier number.

In the meantime, the second sensor corresponding to the small reel detects whether there is identifier information, on the tape retracted or deployed by the small reel, passing through a detection region of the second sensor. One second pulse signal may be outputted each time there is one piece of identifier information passing through the detection region of the second sensor. The number of second pulse signals obtained in the preset time period is counted, so that the number of pieces of identifier information arranged on the tape deployed or retracted by the small reel in the preset time period may be obtained and recorded as a second identifier number.

In step S102, a line speed of the large reel and a line speed of the small reel are calculated based on the counted numbers of the identifiers.

Specifically, the step may include: calculating the line speed of the large reel and the line speed of the small reel based on the preset time period, the first identifier number, the second identifier number and a distance between the identifiers.

It is assumed that the preset time period is 1 s, the number of pieces of identifier information that have passed the detection region of the first sensor in 1 s is N, the number of pieces of identifier information that have passed the detection region of the second sensor in is is P, and the distance between the pieces of identifier information is D. For calculation of the line speed of the large reel, there are two cases.

\textcircled{1} A width of the piece of identifier information may be ignored.

In this case, the line speed of the large reel is y1(t)=(N−1)*D, and

the line speed of the small reel is y2(t)=(P−1)*D.

\textcircled{2} A width of the piece of identifier information is W

In this case, the line speed of the large reel is y1(t)=(N−1)*(W+D), and

the line speed of the small reel is y2(t)=(P−1)*(W+D).

It can be understood that, corresponding equations for calculating the line speeds of the large reel and the small reel may be stored in the temporary banknote storage module by those skilled in the art based on different widths of the pieces of identifier information.

In step S103, a first angular speed and a second angular speed are calculated based on the line speed of the large reel, the line speed of the small reel, an expected line speed and a PID algorithm.

Specifically, the step may include: calculating the first angular speed based on the line speed of the large reel, the expected line speed and the PID algorithm, and calculating the second angular speed based on the line speed of the small reel, the expected line speed and the PID algorithm.

In step S104, the first power motor and the second power motor are respectively controlled based on the first angular speed and the second angular speed.

Specifically, the step may include: controlling a rotational speed of the first power motor corresponding to the large reel based on the first angular speed, to change an angular speed of the first power motor to the first angular speed; and controlling a rotational speed of the second power motor corresponding to the small reel based on the second angular speed, to change an angular speed of the second power motor to the second angular speed.

It can be seen from the above method that, based on the technical solution according to the above embodiment of the present disclosure, the number of passed pieces of identifier information on the tape in a unit of time is detected, and the line speeds of the large reel and the small reel are calculated. Then the first angular speed and the second angular speed are calculated based on the expected line speed and the PID algorithm, and the first power motor corresponding to the large reel and the second power motor corresponding to the small reel are respectively controlled based on the first angular speed and the second angular speed. It can be seen that, in the technical solution according to above embodiment of the present disclosure, calculations of the line speeds of the large reel and the small reel are not affected by a thickness of the tape, a thickness of a banknote and radiuses of the reels, thus the accurate line speeds of the large reel and the small reel may be obtained, and the line speeds of the large reel and the small reel may be kept constant.

It can be understood that, in the above step S103, the calculating the first angular speed and the second angular speed based on the line speed of the large reel, the line speed of the small reel, the expected line speed and the PID algorithm may include: substituting e(t), K_{P}, T_{I} and T_{D} into equation (1) to calculate the first angular speed and the second angular speed:

$$u ( t ) = {K}_{P} [ e ( t ) + \frac{1}{{T}_{I}} {\int }_{0}^{t} e ( t ) d t + \frac{{T}_{D} d e ( t )}{d t} ] \qquad ( 1 )$$

where the e(t)=r(t)−y(t) is a control error of a system, the r(t) is the expected line speed, the y(t) is the line speed of the large reel or an actual line speed of the small reel, the K_{P} is a proportional coefficient, the T_{I} is an integration time constant, and the T_{D} is a derivative time constant. It can be known that the line speed of the large reel and the line speed of the small reel are the actual line speeds of the large reel and the small reel respectively.

It can be understood that, the identifier information on the tape in the present disclosure may include stripes arranged at uniform intervals in the longitudinal direction of the tape, and the strips may include strips of linear shape or strips of other shape. It should be noted that the accuracy of the calculated line speeds of the large reel and the small reel increases with an increasing distribution density of the strips.

It can be understood that, in order to avoid a special case that the line speeds of the large reel and the small reel are much larger than the expected line speed but the rotational speeds of the first power motor and the second power motor can not be effectively changed by a control system, the method according to the above embodiment of the present disclosure may further include:

comparing, the calculated line speed of the large reel and the calculated line speed of the small reel, with the expected line speed respectively, and controlling the temporary banknote storage module to stop operating in a case that a difference between the line speed of the large reel and the expected line speed or a difference between the line speed of the small reel and the expected line speed is greater than a preset value.

It can be understood that, in order to avoid a tape damage due to tape tightening, or a banknote jam due to tape loosening, the method according to the above embodiment of the present disclosure may further include: detecting magnitude of tension of the tape in real time during the operation of the temporary banknote storage module, and controlling the temporary banknote storage module to stop operating in a case that the tension of the tape is larger than a maximum preset tension or the tension of the tape is smaller than a minimum preset tension. Of course, the method may alternatively include: in a case that the tension of the tape is larger than the maximum preset tension, reducing the angular speed corresponding to the first power motor based on a preset proportion if the large reel is retracting the tape and the small reel is deploying the tape, or reducing the angular speed corresponding to the second power motor based on a preset proportion if the small reel is retracting the tape and the large reel is deploying the tape; and in a case that the tension of the tape is smaller than the maximum preset tension, increasing the angular speed corresponding to the first power motor based on a preset proportion if the large reel is retracting the tape and the small reel is deploying the tape, or increasing the angular speed corresponding to the second power motor based on a preset proportion if the small reel is retracting the tape, and the large reel is deploying the tape.

Specifically, the method for detecting the tension may include applying pressure to the tape through a predetermined force at a hovering position on the tape, and calculating the tension of the tape based on magnitude of the predetermined force and a depth of the tape pressed down.

A temporary banknote storage module corresponding to the above method is further provided in the present disclosure.

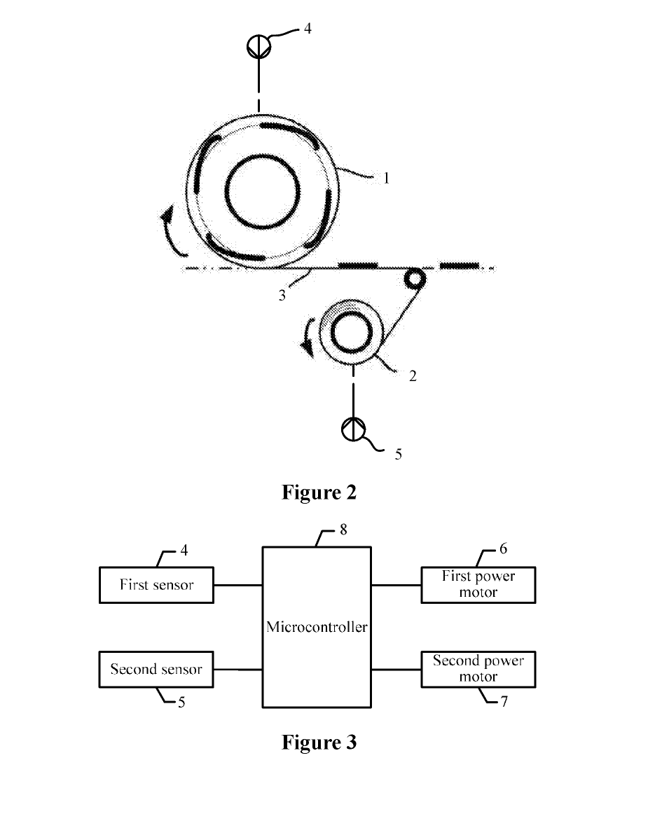

FIG. 2 is a structural diagram of a temporary banknote storage module according to an embodiment of the present disclosure.

FIG. 3 is a diagram of a control principle for the temporary banknote storage module according to an embodiment of the present disclosure.

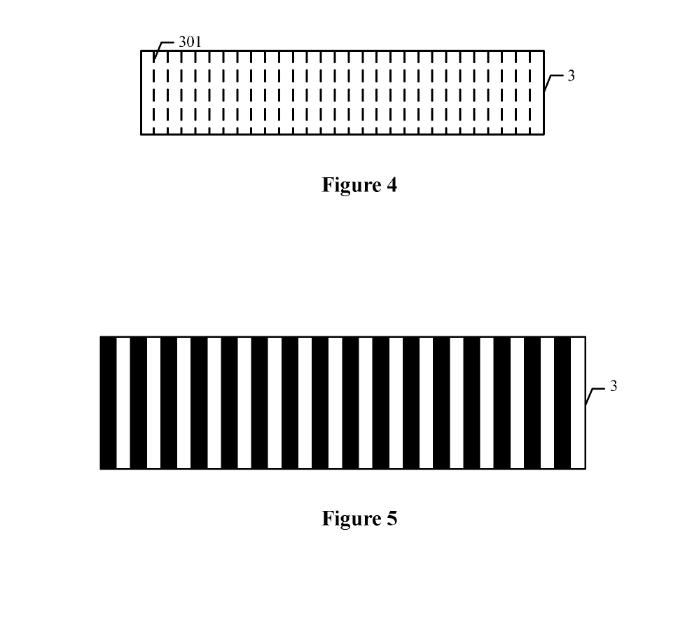

FIG. 4 is a diagram of identifier information on surfaces of a tape in the present disclosure.

Referring to FIG. 2, FIG. 3 and FIG. 4, the temporary banknote storage module according to the embodiment of the present disclosure may include a first power motor 6, a second power motor 7, a large reel 1 driven by the first power motor, a small reel 2 driven by the second power motor, a tape 3 of which two ends are fixed on the large reel 1 and the small reel 2 respectively, a first sensor 4 corresponding to the large reel 1, a second sensor 5 corresponding to the small reel 2, and a microcontroller 8.

The two ends of tape 3 are fixed on the large reel 1 and the small reel 2 respectively, and identifier information 301 are uniformly arranged on the surfaces of the tape 3 in a longitudinal direction. It can be understood that the identifier information are arranged on both surfaces of the tape.

The first sensor 6 corresponding to the large reel 1 is configured to detect the identifier information 301 on the tape 3 retracted or deployed by the large reel 1, and output one piece of first identifier information each time one piece of identifier information is detected, where the first identifier information may be a first pulse signal.

The second sensor 7 corresponding to the small reel 2 is configured to detect the identifier information 301 on the tape 3 retracted or deployed by the small reel 2, and output one piece of second identifier information each time one piece of identifier information is detected, where the second identifier information may be a second pulse signal.

The microcontroller 8 is configured to count the number of pieces of first identifier information obtained in a preset time, record the number of pieces of first identifier information as a first identifier number, count the number of pieces of second identifier information obtained in the preset time, record the number of pieces of second identifier information as a second identifier number, calculate a line speed of the large reel and a line speed of the small reel based on the preset time, the first identifier number, the second identifier number and a distance between the pieces of identifier information, obtain a first angular speed corresponding to the first power motor and a second angular speed corresponding to the second power motor based on an expected line speed and a PID algorithm, and adjust the first power motor and the second power motor based on the first angular speed and the second angular speed.

Referring to FIG. 5, a diagram of a tape is shown according to an embodiment of the present disclosure.

Referring to FIG. 5, black and white stripes of rectangular shape are arranged on surfaces of the tape, and the black strips or white strips may be selected as the identifier information.

It can be understood that, in the temporary banknote storage module according to the above embodiments of the present disclosure, the microcontroller may include a first PID algorithm module and a second PID algorithm module.

The first PID algorithm module is configured to calculate the first angular speed based on the following equation:

$$u 1 ( t ) = {K}_{P} [ e 1 ( t ) + \frac{1}{{T}_{I}} {\int }_{0}^{t} e 1 ( t ) d t + \frac{{T}_{D} d e 1 ( t )}{d t} ] ,$$

where the e1(t)=r(t)−y1(t) is a control error of the large reel of a system, the r(t) is the expected line speed, the y1(t) is the line speed of the large reel, the K_{P} is a proportional coefficient, the T_{I} is an integration time constant, and the T_{D} is a derivative time constant.

The second PID algorithm module is configured to calculate the second angular speed based on the following equation:

$$u 2 ( t ) = {K}_{P} [ e 2 ( t ) + \frac{1}{{T}_{I}} {\int }_{0}^{t} e 2 ( t ) d t + \frac{{T}_{D} d e 2 ( t )}{d t} ] ,$$

where the e2(t)=r(t)−y2(t) is a control error of the large reel of the system, and y2(t) is the line speed of the small reel.

In the temporary banknote storage module according to the above embodiments of the present disclosure, the tape may include a tape, where two ends of the tape are fixed on the large reel and the small reel, strips are arranged at uniform intervals on surfaces of the tape in a longitudinal direction, and the strips are the identifier information of the tape.

It can be understood that the temporary banknote storage module according to the above embodiments of the present disclosure may further include: a speed comparison module, configured to compare the calculated line speed of the large reel and the calculated line speed of the small reel with the expected line speed, and control the temporary banknote storage module to stop operating in a case that the a difference between the line speed of the large reel and the expected line speed is greater than a preset value or a difference between the line speed of the small reel and the expected line speed is greater than the preset value.

It can be understood that the temporary banknote storage module according to the above embodiments of the present disclosure may further include a tester for tension of the tape. The tester for tension of the tape is configured to detect magnitude of the tension of the tape in real time during the operation of the temporary banknote storage module, and send a detected tension signal to the microcontroller. The microcontroller compares the tension with a maximum preset tension and with a minimum preset tension, and controls the temporary banknote storage module to stop operating in a case that the tension of the tape is larger than the maximum preset tension or the tension of the tape is smaller than the minimum preset tension. Of course, the microcontroller may operate alternatively in the following way. In a case that the tension of the tape is larger than the maximum preset tension, the microcontroller reduces the angular speed corresponding to the first power motor based on a preset proportion if the large reel is retracting the tape and the small reel is deploying the tape, or the microcontroller reduces the angular speed corresponding to the second power motor based on a preset proportion if the small reel is retracting the tape and the large reel is deploying the tape. In a case that the tension of the tape is smaller than the maximum preset tension, the microcontroller increases the angular speed corresponding to the first power motor based on a preset proportion if the large reel is retracting the tape and the small reel is deploying the tape, or the microcontroller increases the angular speed corresponding to the second power motor based on a preset proportion if the small reel is retracting the tape, and the large reel is deploying the tape.

Specifically, the tester for the tension of the tape is arranged above or below a hovering position of the tape, applies pressure to the tape through a preset force, and calculates the tension of the tape based on the preset force and a value of a depth of the tape pressed down.

It can be understood that, an automatic teller machine to which a temporary banknote storage module is applied is further provided in the present disclosure.

Finally, it should be noted that, relational terms in the present disclosure such as the first or the second are only used to differentiate one entity or operation from another entity or operation, rather than requiring or indicating the actual existence of the relation or sequence among the entities or operations. In addition, terms such as “include”, “comprise” or any other variants are meant to cover non-exclusive enclosure, so that the process, method, item or device comprising a series of elements not only include the elements but also include other elements which are not specifically listed or the inherent elements of the process, method, item or device. With no more limitations, the element restricted by the phrase “include a . . . ” does not exclude the existence of other same elements in the process, method, item or device including the element.

The embodiments of the present disclosure are described in a progressive way, each of the embodiments places the emphasis upon aspects in which it differs from the other embodiments, and for the same or similar parts of the embodiments, each of the embodiments may be referred to.

The above descriptions of the disclosed embodiments enable those skilled in the art to realize or utilize the present disclosure. Various changes to the embodiments are apparent to those skilled in the art, and general principles defined herein can be realized in other embodiments without departing from the spirit or scope of the present disclosure. Therefore, the present disclosure falls into the widest scope which is consistent with the principles and novel features disclosed herein, rather than being limited to the embodiments described herein.

1. A method for controlling rotational speeds of reels of a temporary banknote storage module, comprising:
counting the number of identifiers detected by a first sensor corresponding to a large reel in a preset time period, and recording the number of identifiers detected by the first sensor as a first identifier number, wherein the identifiers are uniformly arranged in a longitudinal direction of a tape;
counting the number of identifiers detected by a second sensor corresponding to a small reel in the preset time period, and recording the number of identifiers detected by the second sensor as a second identifier number;
calculating a line speed of the large reel and a line speed of the small reel based on the preset time period, the first identifier number, the second identifier number and a distance between the identifiers; and
substituting the line speed of the large reel, the line speed of the small reel and an expected line speed into a PID algorithm, to calculate a first angular speed and a second angular speed, adjusting a rotational speed of a first power motor corresponding to the large reel to be the first angular speed, and adjusting a rotational speed of a second power motor corresponding to the small reel to be the second angular speed.

2. The method according to claim 1, wherein the first angular speed and the second angular speed are calculated in the following step:
calculating the first angular speed and the second angular speed based on an equation:
$$u ( t ) = {K}_{P} [ e ( t ) + \frac{1}{{T}_{I}} {\int }_{0}^{t} e ( t ) d t + \frac{{T}_{D} d e ( t )}{d t} ] ,$$
wherein the e(t)=r(t)−y(t) is a control error of a system, the r(t) is the expected line speed, the y(t) is the line speed of the large reel or an actual line speed of the small reel, the K_{P} is a proportional coefficient, the T_{I} is an integration time constant, and the T_{D} is a derivative time constant.

3. The method according to claim 1, wherein the identifiers comprise stripes arranged at uniform intervals in the longitudinal direction of the tape.

4. The method according to claim 1, further comprising:
comparing, the calculated line speed of the large reel and the calculated line speed of the small reel, with the expected line speed respectively, and controlling the temporary banknote storage module to stop operating in a case that a difference between the line speed of the large reel and the expected line speed or a difference between the line speed of the small reel and the expected line speed is greater than a preset value.

5. The method according to claim 1, further comprising:
detecting magnitude of tension of the tape, and controlling the temporary banknote storage module to stop operating in a case that the tension of the tape is larger than a maximum preset tension or the tension of the tape is smaller than a minimum preset tension.

6. A temporary banknote storage module, comprising:
a first power motor,
a second power motor,
a large reel driven by the first power motor,
a small reel driven by the second power motor,
a tape, wherein two ends of the tape are fixed on the large reel and the small reel respectively, and identifier information are uniformly arranged on surfaces of the tape in a longitudinal direction of the tape;
a first sensor corresponding to the large reel, configured to detect the identifier information on the tape retracted or deployed by the large reel and output one piece of first identifier information each time one piece of identifier information is detected;
a second sensor corresponding to the small reel, configured to detect the identifier information on the tape retracted or deployed by the small reel and output one piece of second identifier information each time one piece of identifier information is detected; and
a microcontroller, configured to count the number of pieces of first identifier information obtained in a preset time, record the number of pieces of first identifier information as a first identifier number, count the number of pieces of second identifier information obtained in the preset time, record the number of pieces of second identifier information as a second identifier number, calculate a line speed of the large reel and a line speed of the small reel based on the preset time, the first identifier number, the second identifier number and a distance between the pieces of identifier information, obtain a first angular speed corresponding to the first power motor and a second angular speed corresponding to the second power motor based on an expected line speed and a PID algorithm, adjust a rotational speed of the first power motor corresponding to the large reel to be the first angular speed, and adjust a rotational speed of the second power motor corresponding to the small reel to be the second angular speed.

7. The temporary banknote storage module according to claim 6, wherein the microcontroller comprises:
a first PID algorithm module, configured to calculate the first angular speed based on an equation:
$$u 1 ( t ) = {K}_{P} [ e 1 ( t ) + \frac{1}{{T}_{I}} {\int }_{0}^{t} e 1 ( t ) d t + \frac{{T}_{D} d e 1 ( t )}{d t} ] ,$$
wherein the e1(t)=r(t)−y1(t) is a control error of the large reel of a system, the r(t) is the expected line speed, the y1(t) is the line speed of the large reel, the K_{P} is a proportional coefficient, the T_{I} is an integration time constant, and the T_{D} is a derivative time constant; and
a second PID algorithm module, configured to calculate the second angular speed based on tan equation:
$$u 2 ( t ) = {K}_{P} [ e 2 ( t ) + \frac{1}{{T}_{I}} {\int }_{0}^{t} e 2 ( t ) d t + \frac{{T}_{D} d e 2 ( t )}{d t} ] ,$$
wherein the e2(t)=r(t)−y2(t) is a control error of the large reel of the system, and the y2(t) is the line speed of the small reel.

8. The temporary banknote storage module according to claim 6, wherein the microcontroller further comprises:
a speed comparison module, configured to compare the calculated line speed of the large reel and the calculated line speed of the small reel with the expected line speed, and control the temporary banknote storage module to stop operating in a case that the a difference between the line speed of the large reel and the expected line speed or a difference between the line speed of the small reel and the expected line speed is greater than a preset value.

9. The temporary banknote storage module according to claim 6, further comprising:
a tester for tension of the tape, configured to detect magnitude of the tension of the tape, wherein
the temporary banknote storage module is controlled to stop operating in a case that the microcontroller detects that the tension of the tape is larger than a maximum preset tension or the tension of the tape is smaller than a minimum preset tension.

10. An automatic teller machine, comprising a temporary banknote storage module according to claim 6.

11. The automatic teller machine, comprising a temporary banknote storage module according to claim 7.

12. The automatic teller machine, comprising a temporary banknote storage module according to claim 8.

13. The automatic teller machine, comprising a temporary banknote storage module according to claim 9.
